(19) United States
(12) Patent Application Publication
(10) Pub. No.: US 2024/0270197 A1
(43) Pub. Date: Aug. 15, 2024

(54) BUCKLE DEVICE

(71) Applicant: KABUSHIKI KAISHA TOKAI-RIKA-DENKI-SEISAKUSHO, Aichi-ken (JP)

(72) Inventors: Ryuji YAMAGUCHI, Aichi (JP); Yoshio MIZUNO, Aichi (JP); Takeru TSUCHIDA, Aichi (JP)

(73) Assignee: KABUSHIKI KAISHA TOKAI-RIKA-DENKI-SEISAKUSHO, Aichi-ken (JP)

(21) Appl. No.: 18/441,471

(22) Filed: Feb. 14, 2024

(30) Foreign Application Priority Data
Feb. 15, 2023 (JP) 2023-022012

(51) Int. Cl. B60R 22/18; B60R 16/027

(52) U.S. Cl. CPC B60R 22/18; B60R 16/027; B60R 2022/1806

(57) ABSTRACT

In a buckle device, a wire harness is connected to a buckle body. In a case in which, at time of light collision of a vehicle, tension is applied to a belt, whereby the belt is extended, and the buckle body is extended, the holding of a slack part of the wire harness by a holding tape is released, and movement of the wire harness is allowed. Here, since the slack part is held by the holding tape, it is possible to stabilize the position of the slack part.

### CROSS-REFERENCE TO RELATED APPLICATION

This application is based on and claims priority under 35 USC 119 from Japanese Patent Application No. 2023-22012 filed on Feb. 15, 2023, the disclosure of which is incorporated by reference herein.

### BACKGROUND

### Technical Field

The present invention relates to a buckle device in which a coupling member is coupled to a buckle body.

### Related Art

In the buckle device disclosed in Japanese Patent Application Laid-Open (JP-A) No. 2019-43449, a load transmission member is coupled to a buckle, and the load transmission member is moved, and the buckle is extended. A wiring is electrically connected to the buckle, and an extra length part is provided at the wiring. The extra length part allows movement of the wiring in a case in which the buckle is extended.

Here, in such a buckle device, it is preferable that the position of the extra length part of the wiring can be stabilized.

### SUMMARY

In view of such circumstances, an object of the invention is to obtain a buckle device capable of stabilizing a position of a slack part of a wiring.

According to a first aspect of the invention, a buckle body configured to engage with a tongue provided at a webbing attached to an occupant, a coupling member that is coupled to the buckle body and is extended by tension applied from the buckle body to extend the buckle body, a wiring that is electrically connected to the buckle body and is provided with a slack part, and a holding member that holds the slack part, and releases holding of the slack part to allow movement of the wiring in a case in which the buckle body is extended.

In the buckle device in the first aspect of the invention, the buckle body is configured to engage with the tongue provided at the webbing attached to the occupant. The coupling member is coupled to the buckle body, and the coupling member is extended by tension applied from the buckle body to the coupling member, whereby the buckle body is extended. The wiring is electrically connected to the buckle body, and the wiring is provided with the slack part.

Here, in a case in which the holding member holds the slack part, and the buckle body is extended, the holding of the slack part by the holding member is released, and the movement of the wiring is allowed. Therefore, it is possible to stabilize the position of the slack part by the holding member holding the slack part.

In a buckle device according to a second aspect of the invention, in the buckle device according to the first aspect of the invention, the holding member holds the slack part by an adhesive force.

In the buckle device according to the second aspect of the invention, the holding member holds the slack part by the adhesive force. Therefore, it is possible to easily hold the slack part.

In a buckle device according to a third aspect of the invention, in the buckle device according to the first or second aspect of the invention, at least one bent part of the wiring is formed at the slack part.

In the buckle device according to the third aspect of the invention, at least one bent part of the wiring is formed at the slack part. Therefore, it is possible to adjust the allowable amount of movement of the wiring by the slack part.

In a buckle device according to a fourth aspect of the invention, in the buckle device according to any one of the first to third aspects of the invention, a side of the slack part of the wiring opposite from the buckle body is fixed.

In the buckle device according to the fourth aspect of the invention, the side of the slack part of the wiring opposite from the buckle body is fixed. Therefore, it is possible to restrict the movement of the wiring to the opposite side from the buckle body.

In a buckle device according to a fifth aspect of the invention, in the buckle device according to any one of the first to fourth aspects of the invention, the holding member integrally or separately holds slack parts of a plurality of wirings.

In the buckle device according to the fifth aspect of the invention, the holding member integrally or separately holds the slack parts of the plurality of the wirings. Therefore, even in a case in which there are a plurality of slack parts, it is possible to stabilize the positions of the plurality of slack parts.

A buckle device according to a sixth aspect of the invention in the buckle device according to any one of the first to fifth aspects of the invention further includes a deformation member that is deformed in a case in which an extension load on the buckle body is equal to or more than a predetermined load, and allows the buckle body to extend.

In the buckle device according to the sixth aspect of the invention, the deformation member is deformed in a case in which the extension load on the buckle body is equal to or more than the predetermined load, and the buckle body is allowed to extend. Therefore, it is possible to reduce a load applied to the occupant from the webbing, and to protect the occupant.

### BRIEF DESCRIPTION OF THE DRAWINGS

Exemplary embodiments of the present invention will be described in detail based on the following figures, wherein:

FIG. 1 is a right side view illustrating a buckle device according to a first embodiment of the invention as viewed from a right;

FIG. 2 is a cutaway view illustrating the buckle device according to the first embodiment of the invention as viewed from the right;

FIG. 3A is a rear view illustrating the buckle device according to the first embodiment of the invention as viewed from the rear;

FIG. 3B is a cross-sectional view illustrating the buckle device according to the first embodiment of the invention at time of light collision of a vehicle as viewed from the right;

FIG. 4 is a plan view illustrating a holding tape in the buckle device according to the first embodiment of the invention;

FIG. 5 is a cutaway view illustrating a buckle device according to a second embodiment of the invention as viewed from the right; and

FIG. 6 is a cutaway view illustrating a buckle device according to a third embodiment of the invention as viewed from the right.

### DETAILED DESCRIPTION

### First Embodiment

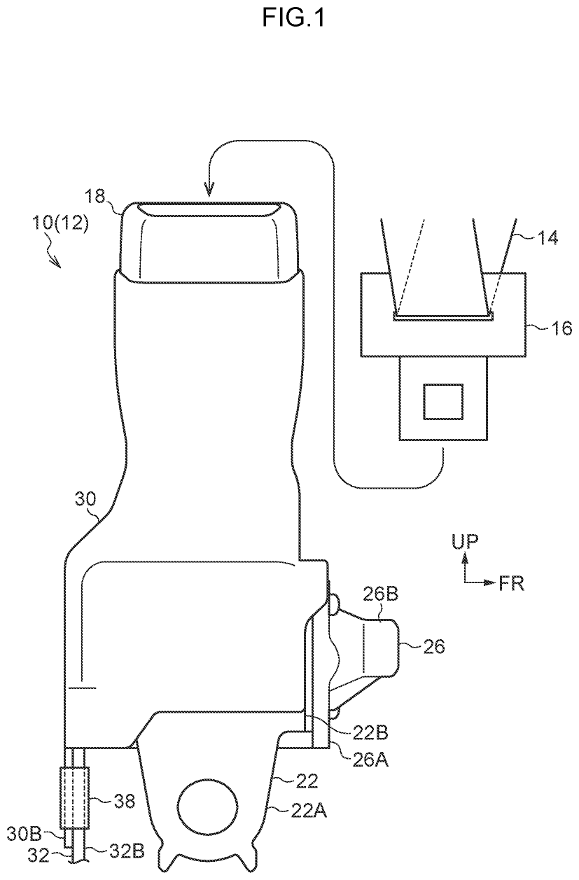

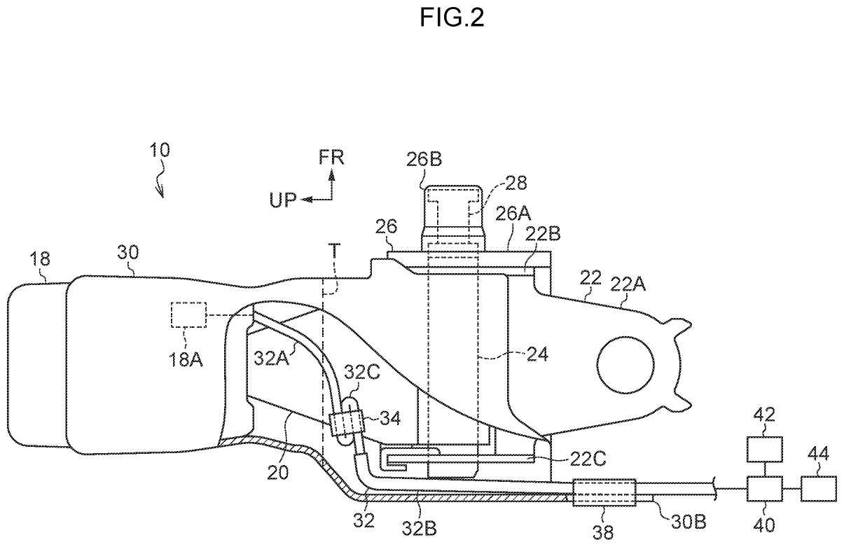

FIG. 1 is right side view illustrating a buckle device 10 according to a first embodiment of the invention as viewed from the right. FIG. 2 is a cutaway view illustrating the buckle device 10 as viewed from the right. In the drawings, the front of the buckle device 10 is indicated by an arrow FR, the right (obverse side) of the buckle device 10 is indicated by an arrow RH, and the upper side of the buckle device 10 is indicated by an arrow UP.

The buckle device 10 according to the present embodiment constitutes a seat belt device 12 of a vehicle (automobile). The seat belt device 12 is applied to a seat (not illustrated) in a vehicle interior. The seat belt device 12 is provided with a winding device (not illustrated). The winding device is installed on the vehicle width direction outer side and the lower side of a seat rear part. In the winding device, a webbing 14 (see FIG. 1) having a long band shape is wound from the proximal end side. A webbing 14 is biased to the winding side to the winding device and pulled out upward from the winding device. The winding device is provided with a lock mechanism, and the lock mechanism locks pulling-out of the webbing 14 from the winding device in an emergency of the vehicle (in collision or the like).

The webbing 14 passes through a through anchor (not illustrated) movably on the distal end side with respect to the winding device. The through anchor is installed on the vehicle width direction outer side and the upper side of the seat rear part. An anchor (not illustrated) is fixed to the distal end part of the webbing 14, and the anchor is installed on the vehicle width direction outer side and the lower side of the seat rear part. The webbing 14 movably passes through a tongue 16 (see FIG. 1) between the through anchor and the anchor.

The buckle device 10 is installed on the vehicle width direction inner side and the lower side of the seat rear part. The front, the right, and the upper side of the buckle device 10 are directed toward the diagonally front bottom, directed inward in the vehicle width direction, and directed toward the diagonally front top, respectively.

As illustrated in FIG. 1, a buckle body 18 having a substantially rectangular parallelepiped shape is provided at an upper part of the buckle device 10. The tongue 16 is engageable with the buckle body 18 from the upper side. The tongue 16 is engaged with the buckle body 18, and the webbing 14 is attached to an occupant seated on the seat. As a result, a part (shoulder webbing) of the webbing 14 between the through anchor and the tongue 16 is stretched obliquely from the shoulder part to the waist part (including the chest part) of the occupant, and a part (wrap webbing) of the webbing 14 between the tongue 16 and the anchor is stretched laterally to the waist part of the occupant. The engagement of the tongue 16 with the buckle body 18 is releasable. The engagement of the tongue 16 with the buckle body 18 is released to release the attachment of the webbing 14 to the occupant. The lower side part of the buckle body 18 gradually becomes smaller downward in the right-left direction.

A buckle switch 18A (see FIG. 2) as a detection unit is provided in the buckle body 18. The buckle switch 18A detects the engagement of the tongue 16 with the buckle body 18 and detects the attachment of the webbing 14 to the occupant. A plurality of buckle switches 18A may be provided.

As illustrated in FIG. 2, a distal-end side part (upper side part) of a band-shaped belt 20 (webbing) as a coupling member is coupled to the lower part of the buckle body 18. The belt 20 is made of, for example, the same material as the material of the webbing 14 and made into a woven fabric.

A frame 22 made of metal as a support is provided in a lower part of the buckle device 10, and the frame 22 is made to have a U-shaped plate shape in a cross section. A back plate 22A is provided at a left part of the frame 22. The frame 22 is fixed to a vehicle body side (for example, a rear part of a seat lower part) at a lower end part of the back plate 22A. Leg plates 22B and 22C are provided at the front part and the rear part of the frame 22, respectively. The leg plates 22B and 22C protrude rightward from the back plate 22A.

A spool 24 that is made of metal and has a substantially cylindrical shape as a winding shaft passes through the leg plates 22B and 22C of the frame 22. The spool 24 is supported by the frame 22. The axial direction of the spool 24 is parallel to the front-rear direction, and the spool 24 is made rotatable about the central axis. A proximal-end side part (lower side part) of the belt 20 is coupled to the spool 24. The belt 20 is wound around the spool 24 and pulled out upward from the left side of the spool 24.

A case 26 that is made of metal as a locking body is disposed on the front side of the frame 22 (leg plate 22B). The case 26 is provided with a regulation plate 26A that has a substantially rectangular plate shape as a restriction part. The regulation plate 26A is fixed to the leg plate 22B, and thus the case 26 is fixed to the leg plate 22B. A locking cylinder 26B having a substantially bottomed cylindrical shape is integrally formed on the front side of the regulation plate 26A. The axial direction of the locking cylinder 26B is parallel to the front-rear direction. The inside of the locking cylinder 26B penetrates the regulation plate 26A and is opened to the rear side of the regulation plate 26A. The front part of the spool 24 is coaxially inserted into the case 26.

A torsion shaft 28 that is made of metal and has a substantially circular columnar shape as a deformation member (energy absorbing member) is coaxially disposed in the case 26. The front end part of the torsion shaft 28 is locked to the front end part in the locking cylinder 26B in a relatively non-rotatable manner. The rear end part of the torsion shaft 28 is coupled to the spool 24 in a relatively non-rotatable manner to restrict the rotation of the spool 24.

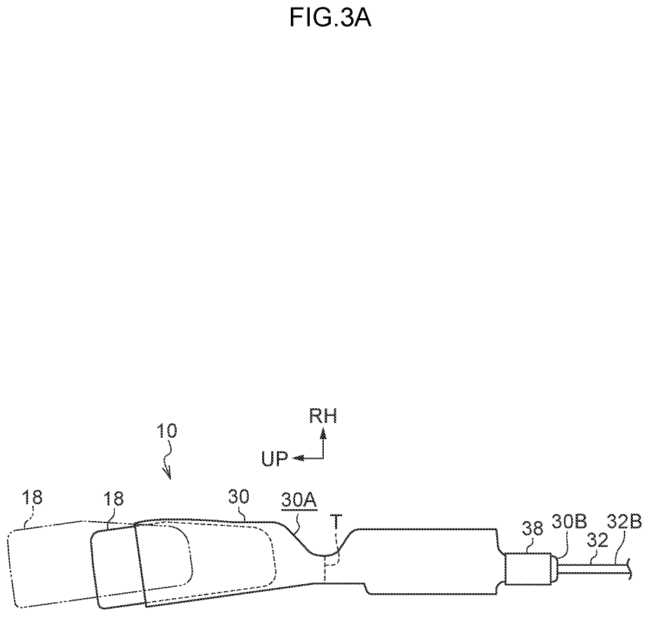

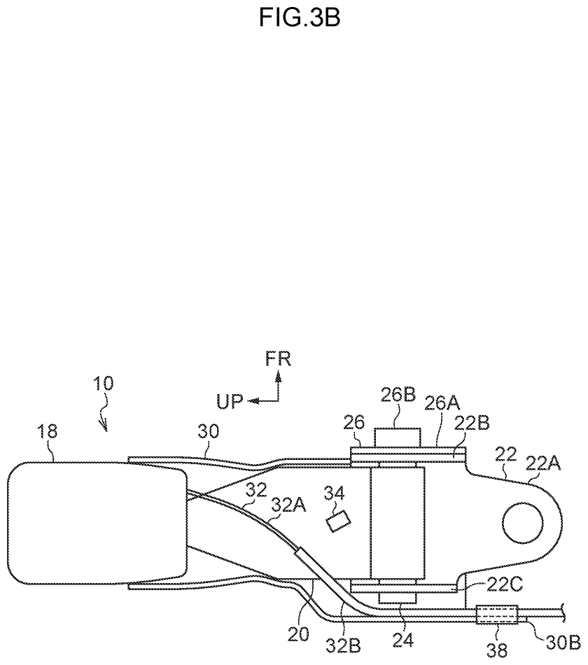

A boot 30 (see FIGS. 2 and 3A) having a substantially rectangular cylindrical shape as a support member is provided in a range from the buckle body 18 to the frame 22. The boot 30 is made of soft resin and has flexibility (elasticity). The upper part of the boot 30 gradually becomes smaller downward in the right-left direction. The lower side part of the buckle body 18 is fitted into the upper part of the boot 30, thereby restricting the downward movement of the buckle body 18. The belt 20 is inserted into the boot 30, and the frame 22 (including the spool 24) is inserted into the lower part of the boot 30. The inside of the lower part of the boot 30 is opened to the front side, and the case 26 protrudes to the front side of the lower part of the boot 30. Just above the lower part in the boot 30 is supported by the frame 22 from the lower side, which restricts the downward movement of the boot 30. An elastic contraction force is applied to the boot 30 between the buckle body 18 and the frame 22 in a state where the belt 20 is wound around the spool 24 as described above, and thus the tension is applied to the belt 20. The boot 30 biases the frame 22 downward to be self-standing with respect to the frame 22 and biases the buckle body 18 upward to be self-standing.

A clip (not illustrated) made of hard resin passes through the lower end part of the left wall of the boot 30 and the back plate 22A of the frame 22. The clip sandwiches the left wall of the boot 30 and the back plate 22A and fixes the boot 30 to the frame 22. A recess 30A having a substantially semi-cylindrical cross section is formed on the right wall of an intermediate part of the boot 30 in the up-down direction. The recess 30A is extended in the front-rear direction and opened to both sides in the front-rear direction. The lowermost position (left end position of the bottom surface) of the recess 30A in the boot 30 is set to the minimum thickness position T of the boot 30, and the boot 30 is elastically bendable in the most right-left direction at the minimum thickness position T. A fixing plate 30B having a rectangular plate shape as a fixing part is integrally formed on the rear wall of the boot 30, and the fixing plate 30B extends downward.

One end of a wire harness 32 as a wiring is electrically connected to the buckle switch 18A in the buckle body 18. The wire harness 32 is routed below the boot 30 from the lower end of the buckle body 18 through the inside of the boot 30 (including a space between the rear wall of the boot 30 and the leg plate 22C of the frame 22). The wire harness 32 is provided with two (may be three or more) electric wires 32A. The electric wire 32A is made into, for example, an AVSS line (thin low-voltage electric wire for an automobile) and is provided with a sheath on the outer periphery. A vinyl tube 32B having a circular tubular shape as a covering tube is provided on the other end side from one end part of the wire harness 32, and the vinyl tube 32B has flexibility. The two electric wires 32A are inserted into the vinyl tube 32B, and the two electric wires 32A are protected by the vinyl tube 32B.

An N-shaped slack part 32C is formed at one end part (a part of only the electric wire 32A) of the wire harness 32, and two bent parts of the wire harness 32 are formed at the slack part 32C.

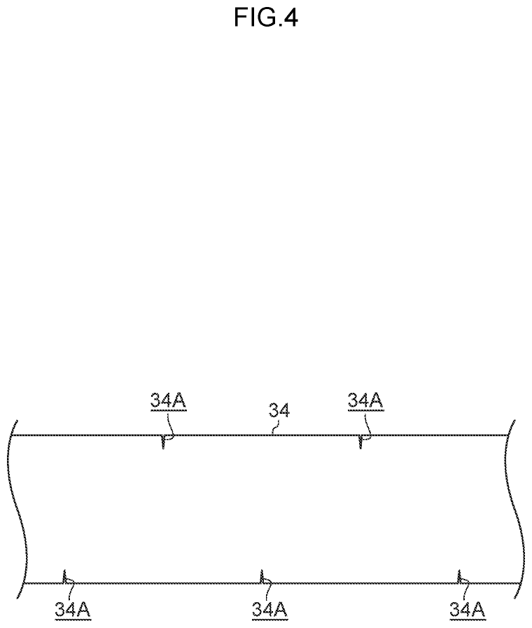

A long rectangular holding tape 34 (for example, an adhesive tape made of vinyl, see FIG. 4.) as the holding member is wound around the outer periphery of the slack part 32C, and the slack part 32C is held by an adhesive force of the holding tape 34. A plurality of slits 34A are formed at both end parts of the holding tape 34 in the width direction. At each end part of the holding tape 34 in the width direction, the slits 34A are arranged at equal intervals in the longitudinal direction of the holding tape 34, and the slit 34A at one end part of the holding tape 34 in the width direction and the slit 34A at the other end part of the holding tape 34 in the width direction are arranged at equal intervals in the longitudinal direction of the holding tape 34. In the wire harness 32, the slack part 32C is held by the holding tape 34 to suppress the movement, and the slack part 32C is disposed below the minimum thickness position T of the boot 30 (or may be disposed above the minimum thickness position T).

A long rectangular fixing tape 38 (adhesive tape) as a fixing member is wound around the outer periphery of the fixing plate 30B of the boot 30 and the wire harness 32, and the wire harness 32 is fixed to the fixing plate 30B by the fixing tape 38. A fixing force of the wire harness 32 to the fixing plate 30B by the fixing tape 38 is larger than the holding force of the slack part 32C of the wire harness 32 by the holding tape 34.

The buckle switch 18A is electrically connected to a control device 40 of the vehicle via the wire harness 32. For example, an airbag device 42 and a warning device 44 of the vehicle are electrically connected to the control device 40. In a case in which the buckle switch 18A does not detect the engagement of the tongue 16 with the buckle body 18 (the attachment of the webbing 14 to the occupant), the airbag device 42 is not actuated at the time of collision of the vehicle or the warning device 44 warns the occupant to urge the attachment of the webbing 14, under the control of the control device 40. In a case in which the buckle switch 18A detects the engagement of the tongue 16 with the buckle body 18 (the attachment of the webbing 14 to the occupant), the airbag device 42 is actuated at the time of collision of the vehicle, or the warning device 44 does not warn the occupant to urge the attachment of the webbing 14, under the control of the control device 40.

Next, the action of the embodiment will be described.

In the seat belt device 12 having the above configuration, in the buckle device 10, the torsion shaft 28 restricts the rotation of the spool 24 to restrict the pulling-out of the belt 20 from the spool 24 and the upward extension of the buckle body 18, and the webbing 14 is attached to the occupant by engaging the tongue 16 of the webbing 14 with the buckle body 18.

At the time of collision of the vehicle (in emergency), the locking mechanism of the winding device locks the pulling-out of the webbing 14 from the winding device, whereby the occupant is restrained by the webbing 14. For example, in a case in which an inertial force is applied to the occupant and the webbing 14 is pulled by the occupant, a pulling force from the spool 24 is applied to the belt 20 from the webbing 14 via the tongue 16 and the buckle body 18, whereby a rotational force is applied to the spool 24.

At the time of collision other than light collision of the vehicle (for example, at the time of high-speed collision), the torsion shaft 28 is deformed to be twisted (plastically deformed) between the front end part and the rear end part by the rotational force applied to the spool 24, and the rotation of the spool 24 is allowed, so that the belt 20 is allowed to be pulled out from the spool 24 and the buckle body 18 (including the tongue 16) is allowed to extend upward. Therefore, a load applied from the webbing 14 to the occupant (particularly, the chest part) is reduced (restricted to a load (force limiter load) twisted deformation of the torsion shaft 28), and kinetic energy of the occupant is absorbed by twisted deformation of the torsion shaft 28, whereby the occupant is protected.

At the time of light collision of the vehicle (for example, at the time of low-speed collision), the torsion shaft 28 is not deformed to be twisted (plastically deformed) between the front end part and the rear end part by the rotational force applied to the spool 24, and the rotation of the spool 24 is not allowed. Tension is applied to the belt 20 by the load from the occupant to the webbing 14, the belt 20 is extended (elastically extended), and the winding part of the belt 20 around the spool 24 is fastened, whereby the buckle body 18 is extended upward by a predetermined distance. After the end of the light collision of the vehicle, the application of the tension to the belt 20 due to the load on the webbing 14 from the occupant is released, the extension of the belt 20 is released, and the winding of the winding part of the belt 20 around the spool 24 is released, whereby the buckle body 18 is moved downward and returned to an initial position.

The slack part 32C of the wire harness 32 is held by the holding tape 34, and the wire harness 32 is fixed to the fixing plate 30B of the boot 30 by the fixing tape 38. The holding force of the slack part 32C by the holding tape 34 is smaller than the fixing force of the wire harness 32 by the fixing tape 38.

Therefore, at the time of the light collision of the vehicle, the buckle body 18 is extended upward, and the wire harness 32 is moved upward integrally with the buckle body 18, whereby the holding of the slack part 32C by the holding tape 34 is released while the fixing of the wire harness 32 by the fixing tape 38 is maintained, and the upward movement of the wire harness 32 is allowed by the slack part 32C (see FIG. 3B). As a result, it is possible to suppress an increase in the tension applied to the wire harness 32, and to suppress disconnection of the wire harness 32.

After the end of the light collision of the vehicle, the buckle body 18 is moved downward and returned to the initial position. Thus, the wire harness 32 is moved downward. Therefore, it is possible to maintain the electrical connection of the wire harness 32, to return the buckle device 10 to the initial state, and to make the replacement of the buckle device 10 unnecessary.

As described above, the slack part 32C of the wire harness 32 is held by the holding tape 34. Therefore, it is possible to stabilize the position of the slack part 32C in the boot 30.

The slack part 32C is not disposed at the minimum thickness position T of the boot 30. Therefore, even though the boot 30 is elastically bent in the right-left direction at the minimum thickness position T, it is possible to suppress damage (for example, disconnection) of the slack part 32C by the boot 30.

The holding tape 34 holds the slack part 32C by the adhesive force. Therefore, it is possible to easily hold the slack part 32C.

In a case in which the slack part 32C comes out of (rubs through) the holding tape 34, the holding of the slack part 32C by the holding tape 34 is released. Therefore, it is possible to reduce the holding force of the slack part 32C by the holding tape 34.

The slack part 32C is made in an N shape, and two (even number) bent parts of the wire harness 32 are formed in the slack part 32C. In the slack part 32C, the wire harness 32 is extended from the holding tape 34 to the opposite sides. Therefore, it is possible to easily cause the slack part 32C to come out of the holding tape 34, and to easily release the holding of the slack part 32C by the holding tape 34.

The slit 34A is formed in the holding tape 34. Therefore, the holding tape 34 can be broken starting from the slit 34A, and the holding force of the slack part 32C by the holding tape 34 can be easily made smaller than the fixing force of the wire harness 32 by the fixing tape 38.

A predetermined number (two in the embodiment) of bent parts of the wire harness 32 are formed in the slack part 32C. Therefore, it is possible to adjust the allowable amount of movement of the wire harness 32 by the slack part 32C in accordance with a distance by which the wire harness 32 moves integrally with the buckle body 18 at the time of the light collision of the vehicle.

The side of the slack part 32C of the wire harness 32 opposite from the buckle body 18 is fixed to the fixing plate 30B of the boot 30 by the fixing tape 38. Therefore, it is possible to restrict the movement of the wire harness 32 to the opposite side of the buckle body 18, and to restrict the movement of the wire harness 32 from the inside of the boot 30 to the lower side (outer side) of the boot 30. In particular, even though the holding of the slack part 32C by the holding tape 34 is released after the end of the light collision of the vehicle, it is possible to restrict the movement of the wire harness 32 from the inside of the boot 30 to the lower side of the boot 30.

### Second Embodiment

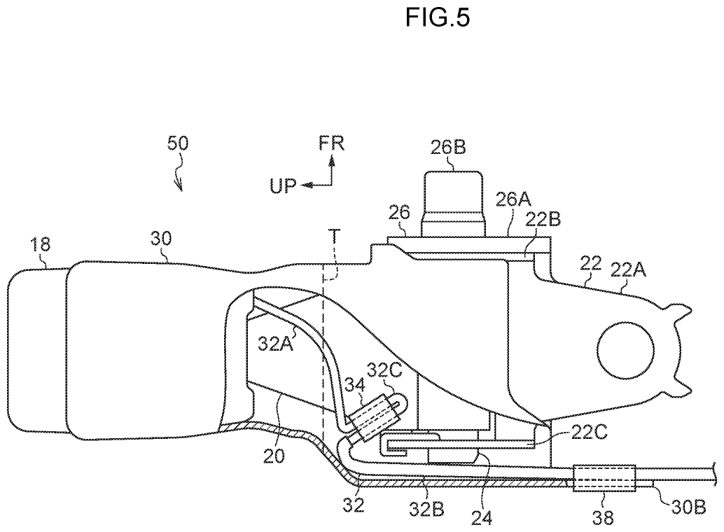

FIG. 5 is a cutaway view illustrating a buckle device 50 according to a second embodiment of the invention as viewed from the right.

The buckle device 50 according to the present embodiment has substantially the similar configuration to the configuration of the first embodiment, but differs in the following points.

As illustrated in FIG. 5, in the buckle device 50 according to the present embodiment, in the wire harness 32, the slack part 32C is made in a U shape, and one (odd number) bent part of the wire harness 32 is formed in the slack part 32C.

Here, also in the embodiment, it is possible to exhibit the similar actions and effects to those of the first embodiment except for the actions and effects obtained by the formation of two (even number) bent parts of the wire harness 32 in the slack part 32C.

### Third Embodiment

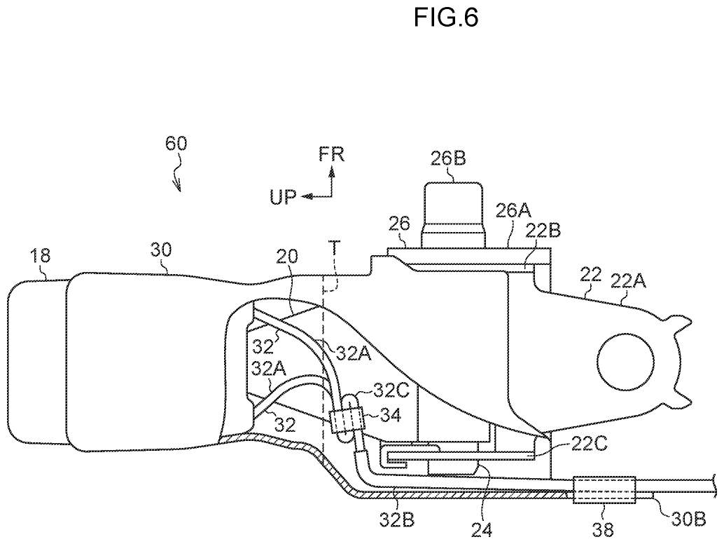

FIG. 6 is a cutaway view illustrating a buckle device 60 according to a third embodiment of the invention as viewed from the right.

The buckle device 60 according to the present embodiment has substantially the similar configuration to the configuration of the first embodiment, but differs in the following points.

As illustrated in FIG. 6, in the buckle device 60 according to the present embodiment, one ends of the two wire harnesses 32 are electrically connected to the buckle switch 18A in the buckle body 18. The slack parts 32C of the two wire harnesses 32 are integrally made and held by the same holding tape 34.

One wire harness 32 corresponds to the airbag device 42, and the other wire harness 32 corresponds to the warning device 44. In a case in which the buckle switch 18A does not detect the engagement of the tongue 16 with the buckle body 18 (the attachment of the webbing 14 to the occupant), the airbag device 42 is not actuated at the time of collision of the vehicle and the warning device 44 warns the occupant to urge the attachment of the webbing 14, under the control of the control device 40. In a case in which the buckle switch 18A detects the engagement of the tongue 16 with the buckle body 18 (the attachment of the webbing 14 to the occupant), the airbag device 42 is actuated at the time of collision of the vehicle, and the warning device 44 does not warn the occupant to urge the attachment of the webbing 14, under the control of the control device 40.

Here, also in the embodiment, it is possible to exhibit the similar actions and effects to those of the first embodiment.

The slack parts 32C of the two wire harnesses 32 are integrated and held by the same holding tape 34. Therefore, even in a case in which there are two slack parts 32C, it is possible to stabilize the positions of the two slack parts 32C in the boot 30.

In the embodiment, the slack parts 32C of the two wire harnesses 32 are integrated and held by the same holding tape 34. The slack parts 32C of the two wire harnesses 32 may be separated and held by different holding tapes 34.

One wire harness 32 is provided in the first and second embodiments, and two wire harnesses 32 are provided in the third embodiment. Three or more wire harnesses 32 may be provided.

Furthermore, two bent parts of the wire harness 32 are formed in the slack part 32C in the first and third embodiments, and one bent part of the wire harness 32 is formed in the slack part 32C in the second embodiment. Three or more bent parts of the wire harness 32 may be formed in the slack part 32C.

In the first to third embodiments, the slit 34A is provided in the holding tape 34. The slit 34A does not need to be provided in the holding tape 34.

In the first to third embodiments, the slack part 32C is held by the adhesive force of the holding tape 34. The slack part 32C may be held by an adhesive force of an adhesive (holding member).

In the first to third embodiments, the side of the slack part 32C of the wire harness 32 opposite from the buckle body 18 is fixed to the boot 30. The side of the slack part 32C of the wire harness 32 opposite from the buckle body 18 may be fixed to the frame 22, the spool 24, or the belt 20.

In the first to third embodiments, the spool 24, the case 26, and the torsion shaft 28 are provided in the frame 22, and the belt 20 is connected to the spool 24. The belt 20 may be coupled to the frame 22 without providing the spool 24, the case 26, and the torsion shaft 28 in the frame 22.

In the first to third embodiments, the deformation member is the torsion shaft 28. The deformation member may be a member other than the torsion shaft 28.

What is claimed is:

1. A buckle device comprising:
a buckle body configured to engage with a tongue provided at a webbing attached to an occupant;
a coupling member that is coupled to the buckle body and is extended by tension applied from the buckle body to extend the buckle body;
a wiring that is electrically connected to the buckle body and is provided with a slack part; and
a holding member that holds the slack part, and releases holding of the slack part to allow movement of the wiring in a case in which the buckle body is extended.

2. The buckle device according to claim 1, wherein the holding member holds the slack part by an adhesive force.

3. The buckle device according to claim 1, wherein at least one bent part of the wiring is formed in the slack part.

4. The buckle device according to claim 1, wherein a side of the slack part of the wiring opposite from the buckle body is fixed.

5. The buckle device according to claim 1, wherein the holding member integrally or separately holds slack parts of a plurality of wirings.

6. The buckle device according to claim 1, further comprising: a deformation member that is deformed in a case in which an extension load on the buckle body is equal to or more than a predetermined load, and allows the buckle body to extend.

7. The buckle device according to claim 1, further comprising: a support member that supports the buckle body and in which the slack part is disposed inside a part thereof other than a part at a minimum thickness position.

8. The buckle device according to claim 1, wherein a side of the slack part of the wiring opposite from the buckle body is fixed, and a holding force of the slack part by the holding member is smaller than a fixing force of the wiring.

9. The buckle device according to claim 1, wherein the holding member is wound around the slack part.

10. The buckle device according to claim 1, wherein a slit is formed in the holding member.
